(19) United States
(12) Patent Application Publication
(10) Pub. No.: US 2026/0311928 A1
(43) Pub. Date: Oct. 8, 2026

(54) ELECTRONIC COMPONENT

(71) Applicant: TDK Corporation, Tokyo (JP)

(72) Inventors: Yoji TOZAWA, Tokyo (JP); Daiki KATO, Tokyo (JP); Junya OKAZAKI, Tokyo (JP); Masashi SHIMOYASU, Tokyo (JP); Emiri HOSOYA, Tokyo (JP); Kazuma TAKAHASHI, Tokyo (JP); Yuya OSHIMA, Tokyo (JP)

(73) Assignee: TDK Corporation, Tokyo (JP)

(21) Appl. No.: 19/634,176

(22) Filed: Mar. 31, 2026

(30) Foreign Application Priority Data
Apr. 2, 2025 (JP) 2025-061018

(51) Int. Cl. H01F 27/29; H01F 17/00; H01F 27/02; H01F 27/28

(52) U.S. Cl. CPC H01F 27/292; H01F 17/0013; H01F 27/027; H01F 27/2804; H01F 2017/0026; H01F 27/2809

(57) ABSTRACT

An electronic component includes an element body and an external electrode disposed on the element body. The external electrode includes a metal plating layer. The metal plating layer includes a first layer, a second layer, and a third layer. The first layer includes Ni. The second layer is located outside the first layer and includes an alloy including Sn. The third layer is located outside the second layer and includes Ni.

### CROSS-REFERENCE TO RELATED APPLICATIONS

This application is based upon and claims the benefit of priority from Japanese Patent Application No. 2025-061018, filed on Apr. 2, 2025, the entire contents of which are incorporated herein by reference.

### BACKGROUND

### Field

One aspect of the present disclosure relates to an electronic component.

### Description of the Related Art

Known electronic components include an element body and an external electrode disposed on the element body (see, for example, Japanese Unexamined Patent Publication No. 2018-019061). The external electrode includes, for example, a plating layer including Ni (nickel) and an outermost plating layer including Sn (tin).

### SUMMARY

An electronic component according to one aspect of the present disclosure includes an element body and an external electrode disposed on the element body and including a metal plating layer. The metal plating layer includes a first layer including Ni, a second layer located outside the first layer and including an alloy including Sn, and a third layer located outside the second layer and including Ni.

### BRIEF DESCRIPTION OF THE DRAWINGS

FIG. 1 is a perspective view illustrating an inductor component according to an example;

FIG. 2 is an exploded perspective view illustrating the inductor component according to the present example;

FIG. 3 is a diagram illustrating a cross-sectional configuration of an external electrode;

FIG. 4 is a diagram illustrating a cross-sectional configuration of an external electrode; and

FIG. 5 is a table illustrating results of a stress simulation.

### DETAILED DESCRIPTION

In the following description, with reference to the drawings, the same reference numbers are assigned to the same components or to similar components having the same function, and overlapping description is omitted.

One aspect of the present disclosure provides an electronic component that improves joint reliability.

The present inventors conducted research and investigation on an electronic component that can improve joint reliability in a state of being mounted on an electronic device. Consequently, the present inventors newly obtained the following findings.

An electronic component is, for example, solder-mounted on an electronic device. The electronic device includes, for example, a circuit board or another electronic component. In a configuration in which the electronic component is solder-mounted on the electronic device, stress may act on the electronic component from the electronic device. The stress acts on the external electrode from a solder fillet formed during solder mounting. In this case, a crack may occur. This crack includes, for example, a solder crack or a product crack. The crack can reduce the joint reliability of the electronic component to the electronic device. Therefore, the electronic component is required to have, for example, improved joint reliability in a state of being solder-mounted on an electronic device.

In a configuration in which the metal plating layer included in the external electrode includes a first layer including Ni, a second layer that is located outside the first layer and includes an alloy including Sn, and a third layer that is located outside the second layer and includes Ni, this configuration reduces stress acting on the external electrode from the solder fillet. In a configuration in which the second layer including the alloy including Sn is located between the first layer and the third layer each including Ni, this configuration tends to suppress the occurrence of cracks and improves the joint reliability of the electronic component to the electronic device.

The present inventors have conceived, for example, the following one aspect based on the above-described newly obtained findings regarding the stress acting on the external electrode from the solder fillet.

One aspect of the present disclosure relates to an electronic component that includes an element body and an external electrode that is disposed on the element body and includes a metal plating layer. The metal plating layer includes a first layer including Ni, a second layer located outside the first layer and including an alloy including Sn, and a third layer located outside the second layer and including Ni.

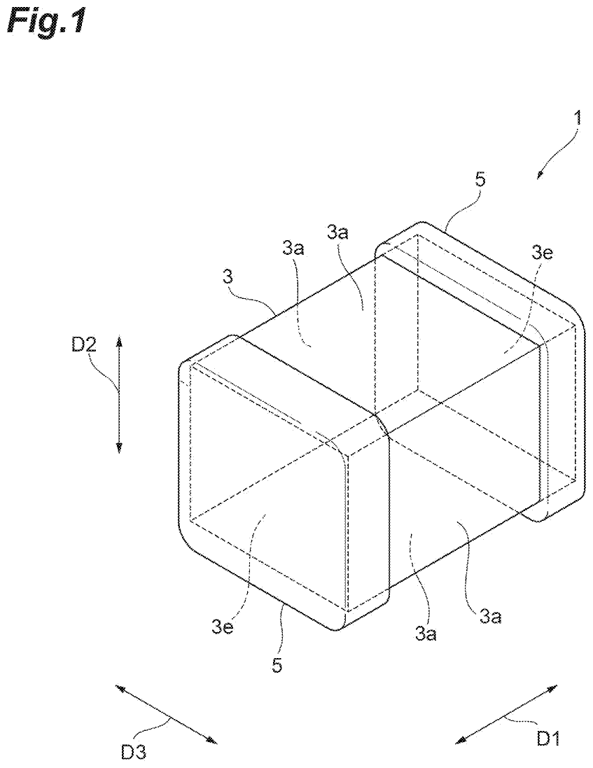

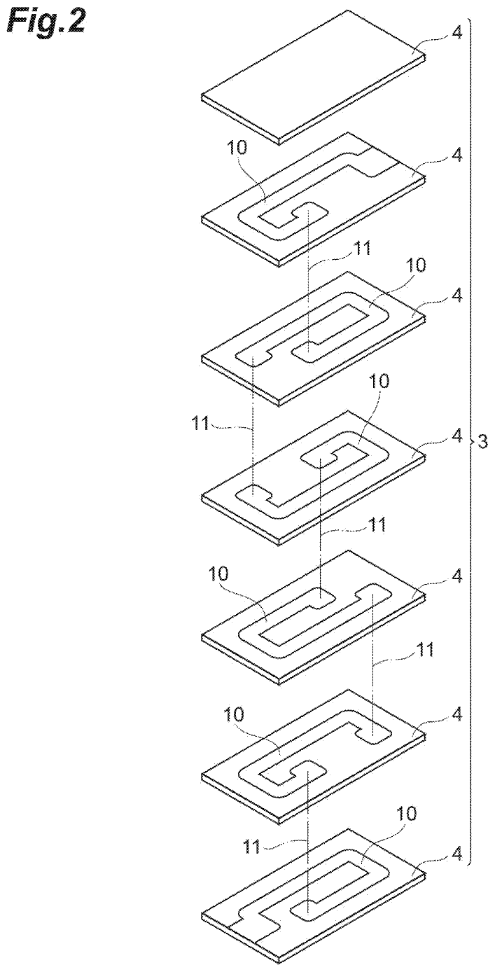

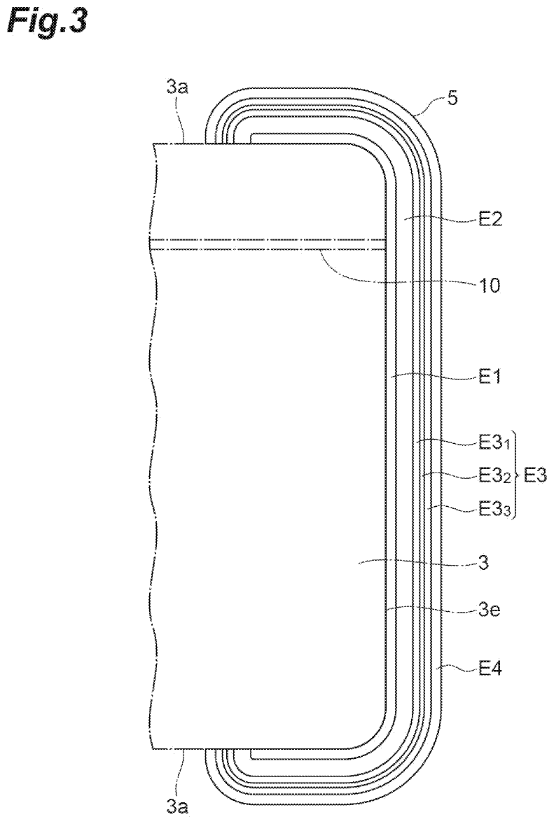

A configuration of an inductor component 1 according to the present example will be described with reference to FIGS. 1 to 3. FIG. 1 is a perspective view of the inductor component according to the present example. FIG. 2 is an exploded perspective view illustrating the inductor component according to the present example. FIG. 3 is a diagram illustrating a cross-sectional configuration of an external electrode.

The electronic component includes, for example, the inductor component 1. The inductor component 1 includes, for example, a multilayer inductor.

As illustrated in FIG. 1, the inductor component 1 includes an element body 3 and a plurality of external electrodes 5. The element body 3 has a rectangular parallelepiped shape. The inductor component 1 includes, for example, a pair of external electrodes 5. The pair of external electrodes 5 are disposed on the element body 3. The pair of external electrodes 5 are separated from each other. The rectangular parallelepiped shape includes a rectangular parallelepiped shape in which corners and ridges are chamfered, or a rectangular parallelepiped shape in which corners and ridges are rounded.

The element body 3 includes four side surfaces 3a and a pair of side surfaces 3e opposing each other. The four side surfaces 3a and the pair of side surfaces 3e have a rectangular shape. The rectangular shape includes, for example, a shape in which each corner is chamfered, or a shape in which each corner is rounded. The four side surfaces 3a include a first pair of side surfaces 3a opposing each other and a second pair of side surfaces 3a opposing each other. A direction in which the first pair of side surfaces 3a oppose each other includes a direction D2. A direction in which the second pair of side surfaces 3a oppose each other includes a direction D3. A direction in which the pair of side surfaces 3e oppose each other includes a direction D1.

The inductor component 1 is solder-mounted on an electronic device. The electronic device includes, for example, a circuit board or another electronic component. In the inductor component 1, one of the four side surfaces 3a opposes the electronic device. One of the four side surfaces 3a is arranged to constitute a mounting surface. One of the four side surfaces 3a includes a mounting surface. For example, one of the first pair of side surfaces 3a includes the mounting surface.

The direction D2 includes a direction perpendicular to the first pair of side surfaces 3a and is perpendicular to the direction D3. The direction D1 includes a direction parallel to the first pair of side surfaces 3a and the second pair of side surfaces 3a. The direction D1 is perpendicular to the direction D2 and the direction D3. The direction D3 includes a direction perpendicular to the second pair of side surfaces 3a. The direction D1 includes a direction perpendicular to the pair of side surfaces 3e.

The first pair of side surfaces 3a extend in the direction D3 to couple the second pair of side surfaces 3a. The first pair of side surfaces 3a extend in the direction D1. The second pair of side surfaces 3a extend in the direction D2 to couple the first pair of side surfaces 3a. The second pair of side surfaces 3a extend in the direction D1. The pair of side surfaces 3e extend in the direction D2 to couple the first pair of side surfaces 3a. The pair of side surfaces 3e extend in the direction D3 to couple the second pair of side surfaces 3a.

A length of the element body 3 in the direction D1 is, for example, greater than a length of the element body 3 in the direction D2 and greater than a length of the element body 3 in the direction D3. The direction D1 includes a longitudinal direction of the element body 3. The length of the element body 3 in the direction D2 and the length of the element body 3 in the direction D3 may be equal to each other. The length of the element body 3 in the direction D2 and the length of the element body 3 in the direction D3 may be different from each other. The length of the element body 3 in the direction D1 may be equal to the length of the element body 3 in the direction D2. The length of the element body 3 in the direction D1 may be equal to the length of the element body 3 in the direction D3.

The length of the element body 3 in the direction D2 includes a height of the element body 3. The length of the element body 3 in the direction D3 includes a width of the element body 3. The length of the element body 3 in the direction D1 includes a longitudinal length of the element body 3. For example, the height of the element body 3 is 0.8 mm, the width of the element body 3 is 0.8 mm, and the longitudinal length of the element body 3 is 1.6 mm.

The element body 3 includes a ridge portion located between the side surface 3e and the side surface 3a and a ridge portion located between one of the first pair of side surfaces 3a and one of the second pair of side surfaces 3a. For example, each ridge portion is rounded to be curved. For example, the element body 3 is subjected to a so-called R-chamfering process. The side surface 3e and the side surface 3a are indirectly adjacent to each other with the ridge portion located between the side surface 3e and the side surface 3a interposed therebetween. One of the first pair of side surfaces 3a and one of the second pair of side surfaces 3a are indirectly adjacent to each other with the ridge portion located between the one of the first pair of side surfaces 3a and the one of the second pair of side surfaces 3a interposed therebetween.

As illustrated in FIG. 2, the element body 3 includes a plurality of element body layers 4. Each of the plurality of element body layers 4 may include an insulator layer. The element body 3 may include a plurality of insulator layers. The plurality of element body layers 4 are, for example, laminated in the direction D2. The element body 3 is configured through laminating the plurality of element body layers 4. In an actual element body 3, the plurality of element body layers 4 may be integrated to an extent that a boundary between the layers is not visible, or may be integrated such that the boundary between the layers is visible.

The plurality of element body layers 4 may include a magnetic material. The magnetic material includes, for example, a ferrite material. The ferrite material includes, for example, a Ni—Cu—Zn-based ferrite material, a Ni—Cu—Zn—Mg-based ferrite material, a Cu—Zn-based ferrite material, or a Ni—Cu-based ferrite material. The plurality of element body layers 4 may include an Fe alloy. The plurality of element body layers 4 may include a non-magnetic material. The non-magnetic material includes, for example, a glass-ceramic material or a dielectric material. The plurality of element body layers 4 may include a resin material.

As illustrated in FIG. 2, the inductor component 1 includes a plurality of inductor conductors 10. Among the plurality of inductor conductors 10, inductor conductors 10 adjacent to each other are electrically connected to each other. The electrical connection between the inductor conductors 10 is established, for example, by an indirect connection through a through-hole conductor 11. The inductor component 1 includes a plurality of through-hole conductors 11. The electrical connection between the inductor conductors 10 may be established by a direct connection between the inductor conductors 10. The plurality of inductor conductors 10 electrically connected to each other constitute a coil having a spiral shape. The inductor component 1 includes a coil disposed in the element body 3. The inductor conductor 10 includes a coil conductor.

The plurality of inductor conductors 10 include a pair of inductor conductors 10 each including one end exposed at a corresponding side surface 3e of the pair of side surfaces 3e. The pair of inductor conductors 10 each including one end exposed at the corresponding side surface 3e are located at both ends of the coil.

The plurality of inductor conductors 10 and the plurality of through-hole conductors 11 include an electrically conductive material. The plurality of inductor conductors 10 and the plurality of through-hole conductors 11 are configured, for example, as a sintered body of an electrically conductive paste including an electrically conductive material. The electrically conductive material included in the inductor conductor 10 and the through-hole conductor 11 includes, for example, Ag, Pd, Au, Pt, Cu, Ni, Al, Mo, or W. The electrically conductive material may include, for example, an Ag—Pd alloy, an Ag—Cu alloy, an Ag—Au alloy, or an Ag—Pt alloy.

As illustrated in FIG. 1, the external electrodes 5 are respectively disposed at both end portions of the element body 3 in the direction D1. The external electrode 5 is disposed on the corresponding side surface 3e of the element body 3. For example, the external electrode 5 is disposed on the four side surfaces 3a and one side surface 3e. The external electrode 5 includes a plurality of electrode portions respectively disposed on corresponding surfaces among the four side surfaces 3a and the one side surface 3e. The external electrode 5 may be disposed on one side surface 3a and one side surface 3e.

The inductor conductor 10 including the one end exposed at the corresponding side surface 3e is connected, at the one end exposed at the corresponding side surface 3e, to the external electrode 5 disposed on the corresponding side surface 3e. The inductor conductor 10 including one end exposed at the corresponding side surface 3e is electrically connected to a corresponding external electrode 5 of the pair of external electrodes 5. The pair of external electrodes 5 are electrically connected to the plurality of inductor conductors 10, that is, the coil.

As illustrated in FIG. 3, the external electrode 5 includes a first electrode layer E1, a second electrode layer E2, a third electrode layer E3, and a fourth electrode layer E4. The first electrode layer E1 is located on the innermost side in the external electrode 5. In FIG. 3, hatching indicating a cross section is omitted.

The first electrode layer E1 is disposed on the element body 3. The first electrode layer E1 is in contact with the element body 3. The inductor conductor 10 including the one end exposed at the corresponding side surface 3e is connected to the first electrode layer E1 included in the corresponding external electrode 5. The first electrode layer E1 is directly connected to the inductor conductor 10 including the one end exposed at the corresponding side surface 3e. The first electrode layer E1 is located on the innermost side in the external electrode 5.

The second electrode layer E2 is located outside the first electrode layer E1. The second electrode layer E2 is disposed on the first electrode layer E1. The second electrode layer E2 is in contact with the first electrode layer E1.

The third electrode layer E3 is located outside the second electrode layer E2. The third electrode layer E3 is disposed on the second electrode layer E2. The third electrode layer E3 is in contact with the second electrode layer E2.

The fourth electrode layer E4 is located outside the third electrode layer E3. The fourth electrode layer E4 is disposed on the third electrode layer E3. The fourth electrode layer E4 is in contact with the third electrode layer E3.

The first electrode layer E1 is formed, for example, through sintering an electrically conductive paste applied onto a surface of the element body 3. The first electrode layer E1 is formed to cover one side surface 3e and a partial region of each of the four side surfaces 3a. The first electrode layer E1 is in contact with the one side surface 3e and the respective partial regions of the four side surfaces 3a. The first electrode layer E1 is formed through sintering a metal component (metal particles) included in the electrically conductive paste. The first electrode layer E1 includes, for example, a sintered metal layer. The first electrode layer E1 includes, for example, a sintered metal layer formed on the element body 3. For example, the first electrode layer E1 includes Ag. The first electrode layer E1 may include an alloy including Ag. The alloy including Ag includes, for example, an Ag—Pd alloy, an Ag—Cu alloy, an Ag—Au alloy, or an Ag—Pt alloy. The electrically conductive paste includes, for example, particles including Ag, a glass component, an organic binder, and an organic solvent. The first electrode layer E1 may include Pd, Au, Pt, Cu, Ni, Al, Mo, or W. A thickness of the first electrode layer E1 is, for example, from 1 to 50 μm.

The second electrode layer E2 is formed, for example, through curing an electrically conductive resin applied on the first electrode layer E1. The second electrode layer E2 is formed on both the first electrode layer E1 and the element body 3. The second electrode layer E2 is in contact with, for example, the first electrode layer E1 and a partial region of each of the four side surfaces 3a. The first electrode layer E1 includes a base metal layer for forming an electrode layer on the first electrode layer E1. The second electrode layer E2 includes, for example, an electrically conductive resin layer covering the first electrode layer E1. The electrically conductive resin includes, for example, a resin, an electrically conductive material, and an organic solvent. The resin includes, for example, a thermosetting resin. The electrically conductive material includes, for example, metal particles. The metal particles include, for example, silver particles. For example, the second electrode layer E2 includes a plurality of silver particles. The thermosetting resin is, for example, a phenol resin, an acrylic resin, a silicone resin, an epoxy resin, or a polyimide resin. The second electrode layer E2 is in contact with the partial region of each of the four side surfaces 3a.

The third electrode layer E3 includes a plurality of layers E3₁, E3₂, and E3₃. The third electrode layer E3 includes, for example, three layers E3₁, E3₂, and E3₃. The plurality of layers E3₁, E3₂, and E3₃ are formed through stacking.

The layer E3₁ is located outside the second electrode layer E2. The layer E3₁ is disposed on the second electrode layer E2. The layer E3₁ is in contact with the second electrode layer E2.

The layer E3₂ is located outside the layer E3₁. The layer E3₂ is disposed on the layer E3₁. The layer E3₂ is in contact with the layer E3₁.

The layer E3₃ is located outside the layer E3₂. The layer E3₃ is disposed on the layer E3₂. The layer E3₃ is in contact with the layer E3₂.

The fourth electrode layer E4 is located outside the layer E3₃. The fourth electrode layer E4 is disposed on the layer E3₃. The fourth electrode layer E4 is in contact with the layer E3₃.

The third electrode layer E3 is formed on the second electrode layer E2 through a plating process. The third electrode layer E3 includes, for example, a metal plating layer. For example, the external electrode 5 includes a metal plating layer located outside the electrically conductive resin layer. The plating process includes, for example, an electrolytic plating process. The third electrode layer E3 includes, for example, an electrolytic plating layer. The layer E3₁ includes Ni. The layer E3₁ may include a trace amount of unavoidable impurities. The layer E3₁ may substantially include only Ni.

The layer E3₂ includes an alloy including Sn. The layer E3₂ may include a trace amount of unavoidable impurities. The layer E3₂ may substantially include only the alloy including Sn. The layer E3₂ may include Ni. The Ni included in the layer E3₂ may be alloyed with Sn. That is, the layer E3₂ may include an alloy of Sn and Ni. Hereinafter, the “alloy of Sn and Ni” may be referred to as a Ni—Sn alloy. The Ni—Sn alloy includes, for example, any one selected from the group consisting of NiSn, Ni₃Sn₂, and Ni₃Sn₄. The alloy of Sn and Ni may include only Ni₃Sn₄. The layer E3₂ may include unalloyed Sn.

The layer E3₃ includes Ni. The layer E3₃ may include a trace amount of unavoidable impurities. The layer E3₃ may substantially include only Ni.

The layer E3₁ may include a first layer, the layer E3₂ may include a second layer, and the layer E3₃ may include a third layer.

The layer E3₂ has, for example, a thickness smaller than a thickness of each of the layer E3₁ and the layer E3₃. A thickness of the layer E3₁ is, for example, from 1.5 to 2 μm. An example of the thickness of the layer E3₁ is 2 μm. A thickness of the layer E3₂ is, for example, from 1 to 1.5 μm. An example of the thickness of the layer E3₂ is 1 μm. A thickness of the layer E3₃ is, for example, from 2 to 3 μm. An example of the thickness of the layer E3₃ is 2 μm. A ratio of the thickness of the layer E3₂ to the thickness of each of the layer E3₁ and the layer E3₃ is, for example, from 0.2 to 0.6.

The fourth electrode layer E4 is formed on the third electrode layer E3 through a plating process. The fourth electrode layer E4 includes, for example, an outermost plating layer. The plating process includes, for example, an electrolytic plating process. The fourth electrode layer E4 includes, for example, an electrolytic plating layer.

The fourth electrode layer E4 includes Sn. The fourth electrode layer E4 may include a trace amount of unavoidable impurities. The fourth electrode layer E4 may substantially include only Sn. The fourth electrode layer E4 may include an outermost plating layer.

A thickness of the fourth electrode layer E4 is, for example, from 4 to 8 μm. An example of the thickness of the fourth electrode layer E4 is 4 μm.

The layer E3₁ is formed, for example, by depositing Ni on the second electrode layer E2 through a barrel plating process using a Watts bath. The layer E3₂ is formed, for example, by depositing an alloy of Sn and Ni on the layer E3₁ through a barrel plating process using a Sn—Ni alloy plating bath. The layer E3₃ is formed, for example, by depositing Ni on the layer E3₂ through a barrel plating process using a Watts bath.

The fourth electrode layer E4 is formed, for example, by depositing Sn on the third electrode layer E3 through a barrel plating process using a Sn plating bath. The Sn plating bath includes, for example, a neutral bath.

A process of forming the layer E3₂ may include, for example, forming a Sn plating layer on the layer E3₁, forming the layer E3₃ on the Sn plating layer formed on the layer E3₁, and heat-treating the layer E3₁, the layer E3₃, and the Sn plating layer. Heat-treating the layer E3₁, the layer E3₃, and the Sn plating layer causes Ni included in the layer E3₁ and layer E3₃ to alloy with Sn included in the Sn plating layer. Alloying the Ni included in the layer E3₁ and layer E3₃ with the Sn included in the Sn plating layer causes to form a layer including a Ni—Sn alloy, that is, the layer E3₂, between the layer E3₁ and the layer E3₃. The layer E3₁, the layer E3₃, and the Sn plating layer may be heat-treated after the fourth electrode layer E4 has been formed. The heat-treating parameters include, for example, a heating temperature and a heating duration. The heating temperature is, for example, from 120 to 200° C. The heating duration is, for example, from 0.5 to 3.0 hours.

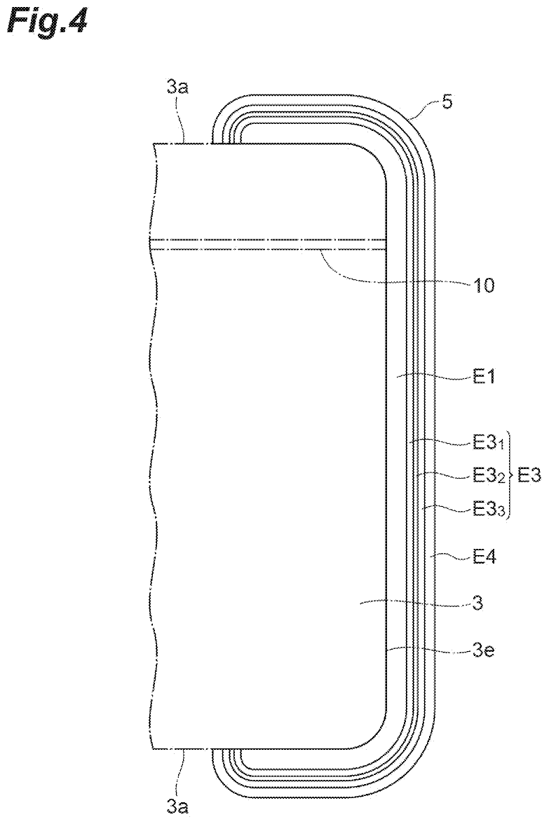

As illustrated in FIG. 4, the external electrode 5 may not include the second electrode layer E2. In the external electrode 5 that does not include the second electrode layer E2, the third electrode layer E3 is disposed on the first electrode layer E1 and is in contact with the first electrode layer E1. The layer E3₁ is disposed on the first electrode layer E1 and is in contact with the first electrode layer E1. FIG. 4 is a diagram illustrating a cross-sectional configuration of an external electrode. In FIG. 4, hatching indicating a cross section is omitted.

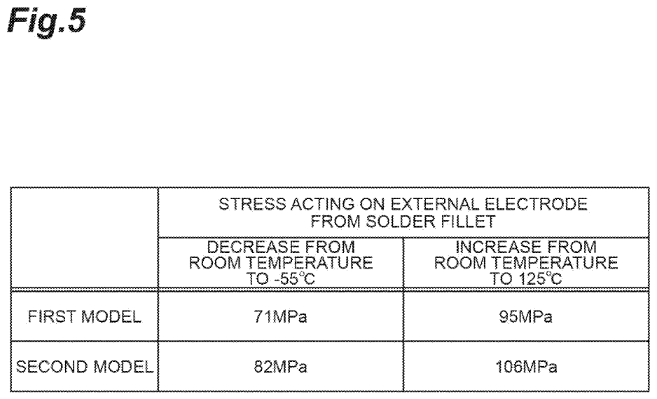

Next, the present inventors performed a stress simulation to clarify the stress acting on the external electrode from the solder fillet. Results of the stress simulation are illustrated in FIG. 5. FIG. 5 is a table illustrating results of a stress simulation.

For the stress simulation, first and second models in which an inductor component is solder-mounted on a substrate were adopted. The substrate has a planar size of 30 mm×10 mm and a thickness of 1.6 mm. In this stress simulation, the stress acting on the external electrode 5 from the solder fillet was determined under two conditions, namely, a decrease in ambient temperature from room temperature to −55° C., and an increase in ambient temperature from room temperature to 125° C. The stress was observed on a central cross-section perpendicular to the side surface 3a arranged to constitute the mounting surface and the side surface 3e. The finite element method is used for the stress simulation.

In the first model, the inductor component includes the configuration of the inductor component 1 illustrated in FIG. 4. The element body 3 includes a ferrite material and has a longitudinal length of 1.6 mm, a width of 0.8 mm, and a height of 0.8 mm. The first electrode layer E1 includes Ag, has a thickness of 20 μm on the side surface 3e, and has a thickness of 10 μm on the side surface 3a. The layer E3₁ is a Ni plating layer and has a thickness of 2.0 μm. The layer E3₂ is a Sn—Ni alloy plating layer and has a thickness of 1.0 μm. The layer E3₃ is a Ni plating layer and has a thickness of 2.0 μm. The fourth electrode layer E4 is a Sn plating layer and has a thickness of 4.0 μm.

In the second model, the inductor component differs from the configuration of the inductor component 1 illustrated in FIG. 4 in the configuration of the third electrode layer E3. In the second model, the third electrode layer E3 included in the external electrode 5 includes only a Ni plating layer having a thickness of 2.0 μm.

As a result of the stress simulation, as illustrated in FIG. 5, the first model reduces the stress acting on the external electrode 5 from the solder fillet. In either model, the stress acting on the external electrode 5 from the solder fillet increases in a region that is not covered by the solder fillet and is in the vicinity of a tip of the solder fillet. In the first model, the above-described region in which the stress increases is narrower compared to in the second model. The numerical values in FIG. 5 are the maximum values of the stress acting on the above-described region.

The present inventors have not performed a stress simulation for the inductor component 1 in which the external electrode 5 includes the second electrode layer E2. However, since the stress generated in the external electrode 5 is based on a force acting from the solder fillet, it is presumed that the stress acting on the external electrode 5 from the solder fillet decreases regardless of the presence or absence of the second electrode layer E2. That is, it is presumed that the inductor component 1 in which the external electrode 5 includes the second electrode layer E2 also reduces the stress acting on the external electrode from the solder fillet, similarly to the inductor component 1 in which the external electrode 5 does not include the second electrode layer E2.

The second electrode layer E2 tends to mitigate the stress generated in the external electrode 5. Therefore, it is presumed that the inductor component 1 in which the external electrode 5 includes the second electrode layer E2 further reduces the stress acting on the external electrode from the solder fillet, as compared to the inductor component 1 in which the external electrode 5 does not include the second electrode layer E2.

As described above, the inductor component 1 reduces the stress acting on the external electrode 5 from the solder fillet. Therefore, the inductor component 1 suppresses occurrence of cracks and improves the joint reliability to the electronic device.

Moisture may remain in an electronic component. Moisture remaining in the electronic component can be a cause of deteriorating the reliability of the electronic component, or a cause of solder splashing during solder-mounting of the electronic component, for example. If a manufacturing process of the electronic component includes an electrolytic plating process, a plating solution may remain in the electronic component due to the electrolytic plating process.

A thickness of a plating layer is affected by, for example, a plating duration. In a case where the plating duration is long, the thickness of the plating layer tends to be large, and in a case where the plating duration is short, the thickness of the plating layer tends to be small. The remaining of moisture is affected by the plating duration in the plating process. In a case where the plating duration is long, moisture tends to remain, and in a case where the plating duration is short, moisture tends not to remain. Therefore, for example, in a case where a thickness of a single plating layer is equivalent to a total thickness of a plurality of stacked plating layers, forming the plurality of plating layers may result in less moisture remaining in the electronic component, although the number of plating processes is larger, as compared to forming the single plating layer.

In the inductor component 1, the third electrode layer E3 includes the plurality of layers E3₁, E3₂, and E3₃. A configuration in which the third electrode layer E3 includes the plurality of layers E3₁, E3₂, and E3₃ may reduce moisture remaining in the inductor component 1.

In the inductor component 1, the layer E3₂ may include an alloy of Sn and Ni.

A configuration in which the layer E3₂ includes an alloy of Sn and Ni improves adhesion the strength between the layers E3₁ and E3₃ including Ni and the layer E3₂.

In a case where the process of forming the layer E3₂ includes heat-treating the layer E3₁, the layer E3₃, and the Sn plating layer, in a configuration in which the Sn plating layer located between the layer E3₁ and the layer E3₃ has a large thickness, the resulting layer E3₂ tends to include unalloyed Sn. In a configuration in which a content of unalloyed Sn is high in the layer E3₂, the unalloyed Sn tends to melt during solder-mounting, and voids may be formed in the layer E3₂. Therefore, in order to reduce the content of unalloyed Sn in the layer E3₂, it is required to reduce the thickness of the Sn plating layer located between the layer E3₁ and the layer E3₃. In a case where the thickness of the Sn plating layer located between the layer E3₁ and the layer E3₃ is small, a thickness of the resulting layer E3₂ is also naturally small.

In the inductor component 1, the thickness of the layer E3₂ may be smaller than the thickness of each of the layer E3₁ and the layer E3₃. In a configuration in which the layer E3₂ has a thickness smaller than the thickness of each of the layer E3₁ and the layer E3₃, the thickness of the layer E3₂ is small, and the layer E3₂ tends to sufficiently include alloyed Sn. Therefore, in this configuration, the formation of the above-described voids can be suppressed.

In a case where the process of forming the layer E3₂ includes heat-treating as described above, in a configuration in which a thickness of the Sn plating layer located between the layer E3₁ and the layer E3₃ is small, an alloy including Sn tends not to be sufficiently formed in the resulting layer E3₂.

In the inductor component 1, the ratio of the thickness of the layer E3₂ to the thickness of each of the layer E3₁ and the layer E3₃ may be from 0.2 to 0.6.

In a configuration in which the above-described ratio is smaller than 0.2, a content of the alloy including Sn in the layer E3₂ may decrease. In a configuration in which the above-described ratio is larger than 0.6, a content of unalloyed Sn in the layer E3₂ may increase, and the content of the alloy including Sn may decrease.

A configuration in which the above-described ratio is from 0.2 to 0.6 suppresses a decrease in the content of the alloy including Sn in the layer E3₂. Therefore, this configuration reliably improves the joint reliability to the electronic device.

It is to be understood that not all aspects, advantages and features described herein may necessarily be achieved by, or included in, any one particular example. Indeed, having described and illustrated various examples herein, it should be apparent that other examples may be modified in arrangement and detail.

The inductor component 1 may include only one inductor conductor 10 instead of the plurality of inductor conductors 10. In a configuration including only one inductor conductor 10, each end of the one inductor conductor 10 are directly connected to the corresponding external electrodes 5.

In the present example, an inductor component has been described as an example of the electronic component. However, an applicable electronic component is not limited to the inductor component. The applicable electronic component is, for example, an electronic component such as a capacitor component, a piezoelectric actuator component, a varistor component, a thermistor component, a solid-state battery component, or a composite component, or an electronic component other than a multilayer electronic component.

What is claimed is:

1. An electronic component, comprising:
an element body; and
an external electrode disposed on the element body and including a metal plating layer, wherein
the metal plating layer includes a first layer including Ni, a second layer located outside the first layer and including an alloy including Sn, and a third layer located outside the second layer and including Ni.

2. The electronic component according to claim 1, wherein
the external electrode further includes a base metal layer that is disposed on the element body and is located on an innermost side in the external electrode.

3. The electronic component according to claim 1, wherein
the external electrode further includes an electrically conductive resin layer, and
the metal plating layer is located outside the electrically conductive resin layer.

4. The electronic component according to claim 3, wherein
the electrically conductive resin layer is in contact with the first layer.

5. The electronic component according to claim 1, wherein
the second layer includes Ni.

6. The electronic component according to claim 5, wherein
the alloy including Sn includes an alloy of Sn and Ni.

7. The electronic component according to claim 1, wherein
the second layer has a thickness smaller than a thickness of each of the first layer and the third layer.

8. The electronic component according to claim 7, wherein
a ratio of the thickness of the second layer to the thickness of each of the first layer and the third layer is from 0.2 to 0.6.

9. The electronic component according to claim 1, further comprising:
an outermost plating layer located outside the metal plating layer and including Sn.

10. The electronic component according to claim 1, further comprising:
an inductor conductor disposed in the element body and connected to the external electrode.
